(19) United States
(12) Patent Application Publication
(10) Pub. No.: US 2015/0370691 A1
(43) Pub. Date: Dec. 24, 2015

(54) SYSTEM TESTING OF SOFTWARE PROGRAMS EXECUTING ON MODULAR FRAMEWORKS

(71) Applicant: EINFOCHIPS Inc, Sunnyvale, CA (US)

(72) Inventor: Manoj R Pandey, Ahmedabad (IN)

(21) Appl. No.: 14/307,513

(22) Filed: Jun. 18, 2014

(51) Int. Cl. G06F 11/36

(52) U.S. Cl. CPC G06F 11/3688; G06F 11/3692

(57) ABSTRACT

According to an aspect of the present disclosure, a test case specifying multiple tasks is run on a software program executing on a modular framework, with the performance of each task (by the software program) being designed to cause invocation of some of the modules of the framework. A set of modules of the modular framework as being of interest in the running of the test case is identified. Accordingly, icons representing the identified set of modules are displayed during the performance of the tasks of the test case. Upon occurrence of an error condition, a module of interest causing the error condition is diagnosed, and the icon representing the module of interest is highlighted to indicate to a user that the module is the source of the error condition. Thus, a user is enabled to perform the system testing of software programs executing on a modular framework.

### BACKGROUND OF THE DISCLOSURE

1. Technical Field

The present disclosure relates to testing of software systems, and more specifically to system testing of a software program executing on a modular framework.

2. Related Art

System testing refers to checking whether a software program, as an overall system (or black box), is compliant with the expected functional requirements for which the software program is designed. The test cases thus are focused on testing of the functionality (inputs and outputs), rather than the internals of the software program. Often, the source code of the software program is unavailable or not required, for the purpose of system testing, as is well known in the relevant arts.

Modular frameworks are often provided as a platform for execution of software programs. A modular framework is characterized by modules, which are exposed in terms of one or more aspects such as identity (having a unique identifier for each module), invocability of procedures defined within each module by software programs, etc. The modules may also provide traceability, i.e., provide information about its internal operation, during execution. As may be readily appreciated, several different modules may be executed during system testing of a software program.

Aspects of the present disclosure simplify system testing of software programs executing on a modular framework.

### BRIEF DESCRIPTION OF THE DRAWINGS

Example embodiments of the present disclosure will be described with reference to the accompanying drawings briefly described below.

FIG. 1 is a block diagram illustrating an example environment (computing system) in which several aspects of the present disclosure can be implemented.

FIG. 2 is a flow chart illustrating the manner in which the system testing of a software program executing on a modular framework is facilitated according to an aspect of the present disclosure.

FIG. 3A is a block diagram illustrating the various modules of a modular framework in one embodiment.

FIG. 3B depicts the manner in which a system error/error condition is determined (in a first phase) in one embodiment.

FIGS. 4A-4C together illustrates the manner in which icons representing modules of interest are displayed (and highlighted) during the performance of a test case (in a second phase) in one embodiment.

FIG. 4D depicts the manner in which log data is provided in response to users selecting a highlighted module in one embodiment.

FIG. 5 is a block diagram of a testing tool facilitating system testing of a software program executing on a modular framework in one embodiment.

FIG. 6A depicts a portion of a configuration data in one embodiment.

FIG. 6B depicts a portion of an activity stack data provided by a modular framework in one embodiment.

FIG. 6C depicts a portion of a log data generated by a modular framework in one embodiment.

FIG. 7 is a block diagram illustrating the details of a digital processing system in which various aspects of the present disclosure are operative by execution of appropriate software instructions.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

An aspect of the present disclosure facilitates system testing of software programs executing on a modular framework. In an embodiment, a test case specifying multiple tasks is run on a software program executing on a modular framework, with the performance of each task (by the software program) being designed to cause invocation of some of the modules of the framework. A set of modules of the modular framework, which are of interest in the running of the test case, is identified (for example, by examining a configuration data). Accordingly, icons representing the identified modules are displayed during the performance of the tasks of the test case. Upon occurrence of an error condition, a module of interest causing the error condition is diagnosed, and the icon representing the module of interest is highlighted to indicate to a user that the module is the source of the error condition.

Thus, a user is enabled to determine whether any of the modules of interest in a modular framework is the source of error conditions during execution of a software program. The user is accordingly facilitated to perform the system testing of the software program executing on a modular framework.

In one embodiment, the software program is executed and the corresponding test case is run in a non-debug mode during a first phase, and then later executed/run in a debug mode during a second phase, with the second phase (debug mode) being performed only if the error condition (noted above) occurs in the first phase (non-debug mode).

According to another aspect of the present disclosure, a log data generated by the modular framework during the performance of the test case is captured. Upon occurrence of an error condition, the icon representing the diagnosed module operates as a widget in the duration when highlighted, wherein in response to a user selecting the widget, a corresponding portion of the log data generated by the modules of interest is provided to the user. As such, the user is facilitated to determine a cause of the error condition based on the corresponding portion of the log data.

According to one more aspect of the present disclosure, a test case specifying multiple tasks is run on a software program executing on a modular framework, with the performance of each task (by the software program) being designed to cause invocation of modules of the framework. During the performance of each task, icons representing a set of modules of interest are displayed as an overlay on the display of the output of performance of the task. In other words, the output of the performance of the task and the icons are simultaneously visible to the user on the display. Such a feature facilitates the user to identify whether any of the specific modules of interest in a modular framework are invoked during the performance of each task (of the test case).

Several aspects of the present disclosure are described below with reference to examples for illustration. However, one skilled in the relevant arts will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

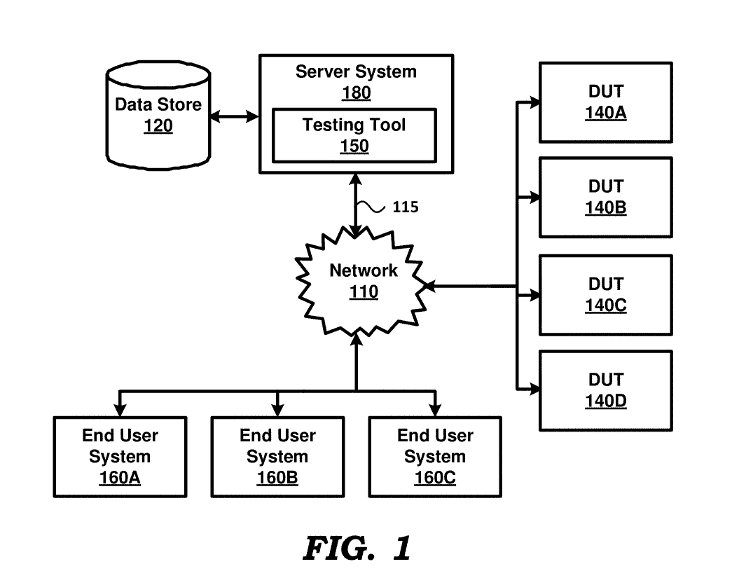

FIG. 1 is a block diagram illustrating an example environment (computing system) in which several aspects of the present disclosure can be implemented. The block diagram is shown containing network 110, data store 120, devices under test (DUTs) 140A-140D, end user systems 160A-160C and server system 180 (shown executing testing tool 150).

Merely for illustration, only representative number/type of systems is shown in the Figure. Many environments often contain many more systems, both in number and type, depending on the purpose for which the environment is designed. Each system/device of FIG. 1 is described below in further detail.

Network 110 provides connectivity between DUTs 140A-140D, end user systems 160A-160C and server system 180, and may be implemented using protocols such as Transmission Control Protocol (TCP) and/or Internet Protocol (IP), well known in the relevant arts. In general, in TCP/IP environments, an IP packet is used as a basic unit of transport, with the source address being set to the IP address assigned to the source system from which the packet originates and the destination address set to the IP address of the destination system to which the packet is to be eventually delivered.

A (IP) packet is said to be directed to a destination system when the destination IP address of the packet is set to the (IP) address of the destination system, such that the packet is eventually delivered to the destination system by network 110. When the packet contains content such as port numbers, which specifies the destination application, the packet may be said to be directed to such application as well. The destination system may be required to keep the corresponding port numbers available/open, and process the packets with the corresponding destination ports.

Network 110 may be implemented using any combination of wire-based or wireless mediums. While the description below is provided assuming that network 110 is implemented using TCP/IP protocols, it may be appreciated that in alternative embodiment, some of the connectivity (for example, between DUTs 140A-140D and server system 180) may be implemented by directly connecting corresponding ports (such as serial, parallel, USB, etc.) and using protocols such as RS-232, as will be apparent to one skilled in the relevant arts by reading the disclosure herein.

Data store 120 represents a non-volatile (persistent) storage facilitating storage and retrieval of data (such as the details of the DUTs, the software programs executing on the DUTs, the test cases to be performed on each software program, the results of performance of each test case, etc.) by applications executing in server system 180. Data store 120 may be implemented as a corresponding database server using relational database technologies and accordingly provide storage and retrieval of data using structured queries such as SQL (Structured Query Language). Alternatively, data store 120 may be implemented as a corresponding file server providing storage and retrieval of data in the form of files organized as one or more directories, as is well known in the relevant arts.

Each of devices under test (DUTs) 140A-140D represents a system such as a personal computer, workstation, mobile station, mobile device, computing tablet, etc., that provides a modular framework for execution of software programs sought to be tested. The modular framework may include modules from one or more of an operating system (e.g., Microsoft Windows XP, Linux, Google Android, Apple IOS, etc.), a virtual machine (e.g., Oracle's Java Virtual Machine, Microsoft's CLR), an application framework (Oracle Software Development Kit (SDK), Android SDK), and a lower level library (e.g., device drivers controlling hardware).

Each of end user systems 160A-160C represents a system such as a personal computer, workstation, mobile station, etc., used by users to generate (user) requests directed to applications executing in server system 180. The user requests may include a request to perform one or more test cases on a specific software program executing in a DUT (140A-140D), the specific tasks to be performed as part of the test case, a request to provide the result of performance of the test cases, etc. The results may be provided to the end user system and/or displayed on the tested DUT.

The user requests may be generated using appropriate user interfaces (for example, web pages provided by applications executing in server system 180). In general, an end user system sends user requests to an application (executing in server system 180) for performing desired tasks/services and receives corresponding responses containing the results of performance of the requested tasks/services.

Server system 180 represents a server, such as a web/application server, executing applications/software based tools (e.g., testing tool 150) capable of processing (user) requests received from users using one of end user systems 160A-160C. Server system 180 may use data stored internally (for example, in a non-volatile storage/hard disk within the system), external data (for example, stored in data stores such as 120) and/or data received from external sources (e.g., from the user) in processing of the user requests. The server system then sends the result of processing of the user requests to the requesting end user system (one of 160A-160C).

Testing tool 150 represents a testing application (executing in server system 180) that enables a user to perform system testing of a software program executing on a modular framework on DUTs (say 140A, for illustration). Testing tool 150 retrieves test cases from data store 120 and executes the test cases on software programs executing on DUTs. The manner in which testing tool 150 facilitates users to test software programs conveniently, is described below with examples.

### 3. System Testing of a Software Program Executing on a Modular Framework

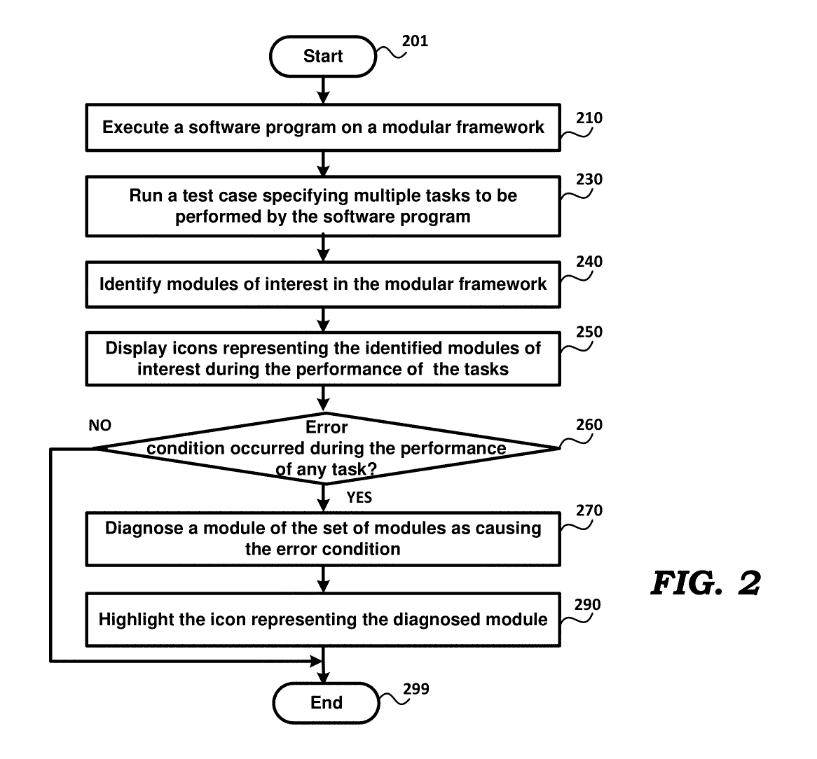

FIG. 2 is a flow chart illustrating the manner in which the system testing of a software program executing on a modular framework is facilitated according to an aspect of the present disclosure. The flowchart is described with respect to testing tool 150 and DUT 140A of FIG. 1 merely for illustration. However, many of the features can be implemented in other environments also without departing from the scope and spirit of several aspects of the present disclosure, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present disclosure. The flow chart begins in step 201, in which control immediately passes to step 210.

In step 210, a software program is executed on a modular framework provided on DUT 140A. The software program may be executed in response to appropriate commands issued directly on DUT 140A. Alternatively a user may issue requests from one of end user systems 160A-160C, with testing tool 150 then sending appropriate commands for initiating execution of the software program on DUT 140A.

In step 230, testing tool 150 runs a test case on the software program. As noted above, each test case specifies multiple tasks, with the performance of each task (by the executing software program) being designed to cause invocation of some of the modules of the framework. The test case may be run in response to receiving a request from a user using one of end user systems 160A-160C. The received request may indicate the test case and the software program.

In step 240, testing tool 150 identifies (a set of) modules of interest in the modular framework. In an embodiment described below, such modules of interest are specified in a configuration file. The identification in such a situation entails, examining the content of the configuration file to identify the set of modules. However, alternative techniques such as specifying the set of modules in command lines, etc., may also be employed without departing from the scope and spirit of the present invention. In general, it may be appreciated that a modular framework may contain many (e.g., several hundreds) modules, while it may be known a priori that very few of such modules can be the source of error conditions during such system testing. Such modules are identified as the set of modules of interest.

In step 250, testing tool 150 displays icons representing the identified set of modules of interest during the performance of various tasks specified in the test case. An icon is a picture or graphical representation (contrasted with mere textual representation) with visual characteristics such as shape, color, etc., as is well known in the relevant arts.

According to an aspect of the present disclosure, the icons are displayed as an overlay over the output of the software program (during the performance of each task). An overlay implies that the icons and the output of the software program share the same display area portion in the same time instances of a duration. In other words, the icons and the output are simultaneously visible to a user on a display unit associated with DUT 140A (not shown in FIG. 1).

In step 260, testing tool 150 determines whether an error condition occurred during the performance of any task (of the test case). An error condition refers to deviation from expected operation of the software program (being tested), for the specific test case being run. The expected operation for a given task can be in terms of expected functionality, output, etc. Such error conditions can be determined based on any approach (human or automated) available in the corresponding environment of DUT 140A. Control passes to step 270 if such an error condition is identified and to step 299 otherwise, where the flow chart ends.

In step 270, testing tool 150 diagnoses a module of the set of modules (of interest) as causing the error condition. For example, the diagnosis may be performed by inspecting a log data generated (by various modules of the modular framework) during execution of the software program. Alternatively, the modular framework may provide software hooks to which testing tool 150 may be associated such that modular framework notifies testing tool 150 of any error conditions (along with associated details) occurring during testing. In general, the module can be diagnosed based (also) on any approach available in the corresponding environment of DUT 140A.

In step 290, testing tool 150 highlights the icon representing the diagnosed module. Highlighting implies that the visual characteristics of the icon are shown to be different from those of the icons representing the other modules. In one embodiment, the highlighted icon operates as a widget which can be selected by a user. In response to the user selecting the widget, a portion of the log data generated by the modules of interest is provided to the user. The flowchart ends in step 299.

Thus, a user is enabled to determine whether any of the modules of interest in a modular framework is the source of error conditions during execution of a software program. In one embodiment, the software program is added as a module, thereby facilitating the user to determine whether the error condition is caused by the software program or the framework.

The manner in which testing tool 150 facilitates the system testing of software programs executing on a modular framework according to the steps of FIG. 2 is described below with examples.

### 4. Illustrative Example

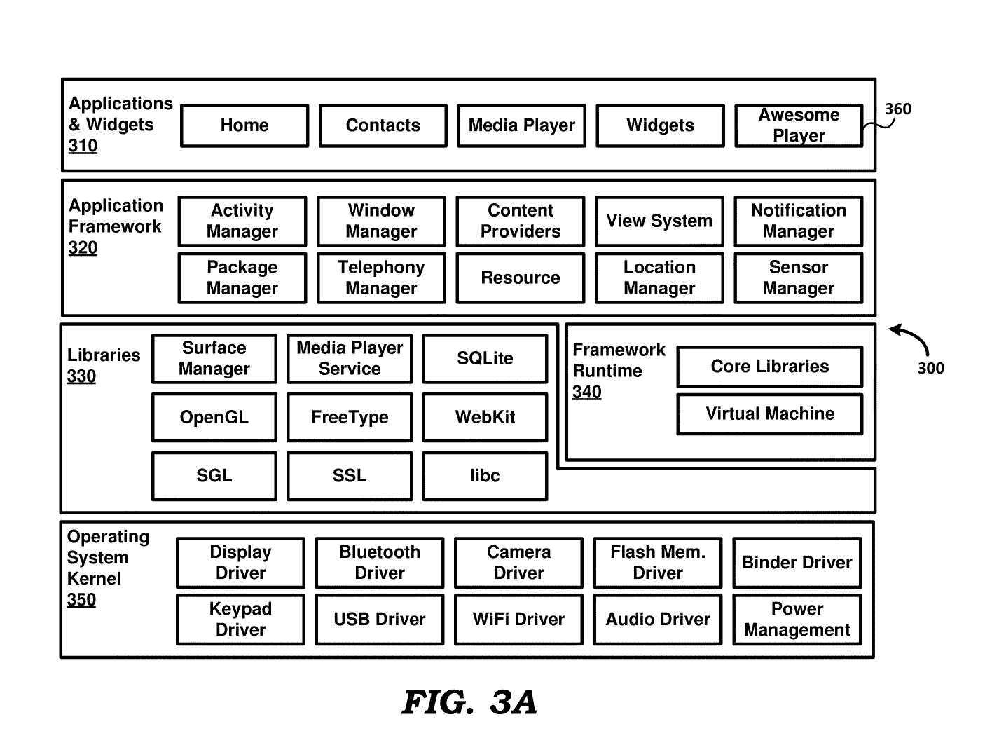

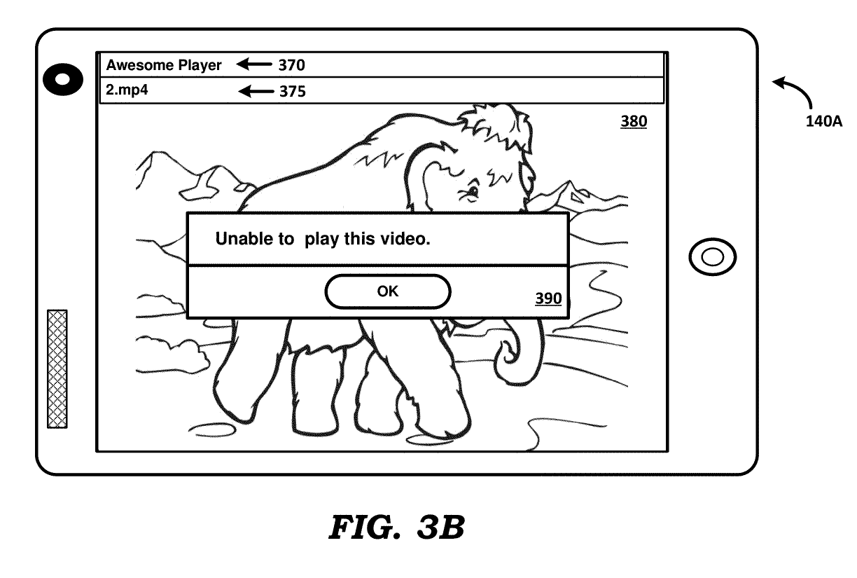

FIGS. 3A-3B, 4A-4D, 5 and 6A-6C together illustrate the manner in which system testing of a software program executing on a modular framework is facilitated in one embodiment. For illustration, DUT 140A is assumed to be a mobile device on which the modular framework is provided, and accordingly the testing of software programs executing on such a mobile device is described in detail below. However, the features of the present disclosure may be implemented for testing software programs executing on other types of devices and/or frameworks as well, as will be apparent to one skilled in the relevant arts by reading the disclosure herein. Each of the Figures is described in detail below.

FIG. 3A is a block diagram illustrating the various modules of a modular framework in one embodiment. Framework 300 represents a modular framework such as the Android™ operating system executing in (and provided on) a mobile device (DUT 140A). It may be observed that framework 300 includes various modules such as Media Player, Activity Manager, Media Player Service, etc. organized as different groups.

Applications & widgets 310 include system tools provided as part of the operating system (e.g., Browser, Widgets, Media Player, contacts/address book, Home/default display screen) and other user applications (e.g. Awesome Player 360). These are tools normally shipped as a part of the modular framework, for use by the mobile users. Application framework 320 provides modules for managing the various hardware/software features of the mobile device such as the activities, windows, telephony, etc. Libraries 330 include third-party modules (such as SQLite, SSL) that are shipped along with the operating system. Framework runtime 340 includes a virtual machine on which the modules are executed. Operating system kernel 350 contains modules/device drivers for interfacing with the underlying hardware of the mobile device.

Thus, modular framework 300 contains various modules that facilitates the execution of a software program (user application) such as awesome player 360 in DUT 140A. In response to a user sending a request (from one of end user systems 160A-160C) to execute a test case on a software program executing in DUT 140A, testing tool 150 retrieves the requested test case from data store 120 and executes the tasks specified in the test case on the software program (assumed to be awesome player 360 for illustration).

In one embodiment, testing tool 150 executes runs the tasks of a user requested test case in a non-debug mode during a first phase. In a scenario that an error condition is determined to have occurred during the first phase, the tasks of the test case may be performed again in a debug mode during a second phase. In other words, the second phase (debug mode) is performed only if the error condition (noted above) occurs in the first phase (non-debug mode).

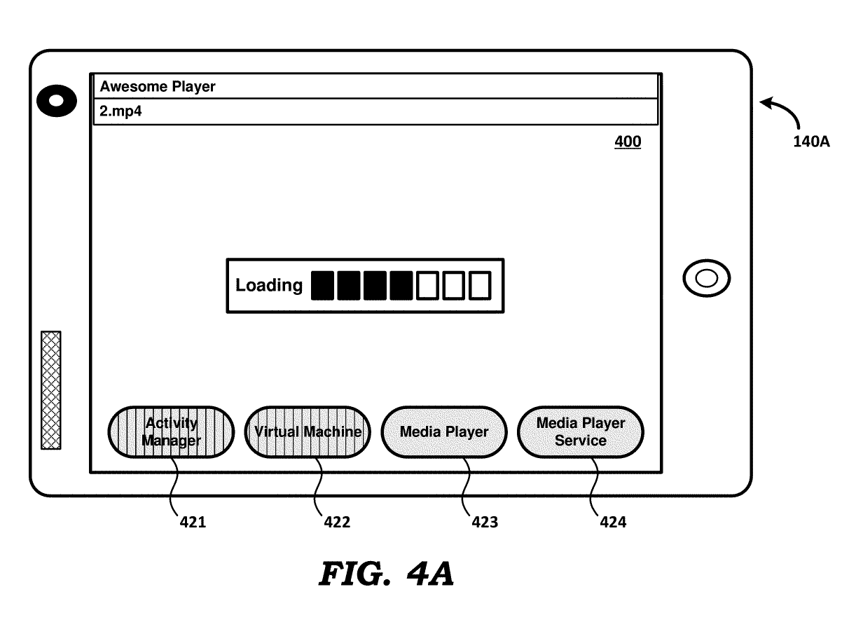

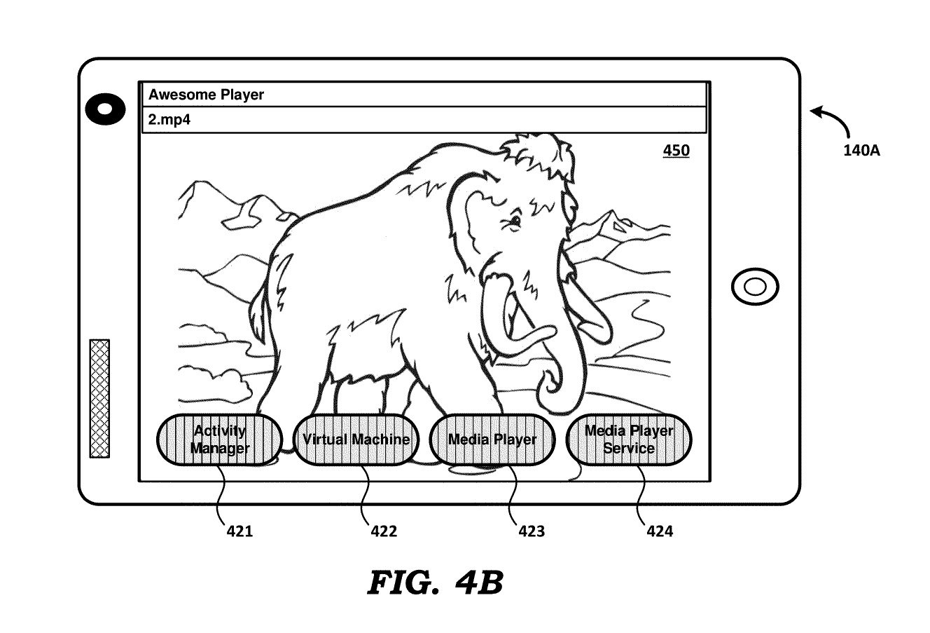

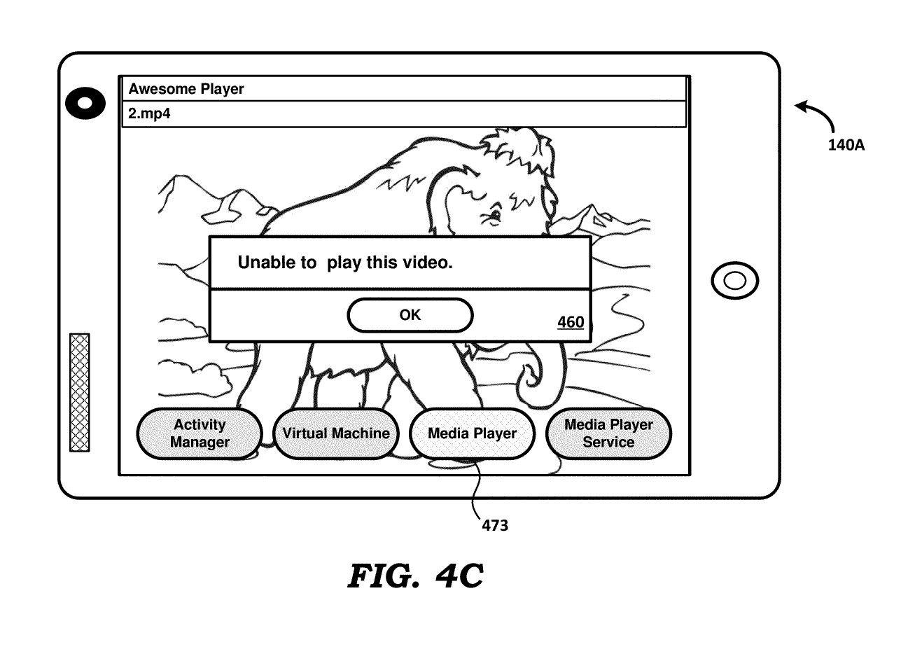

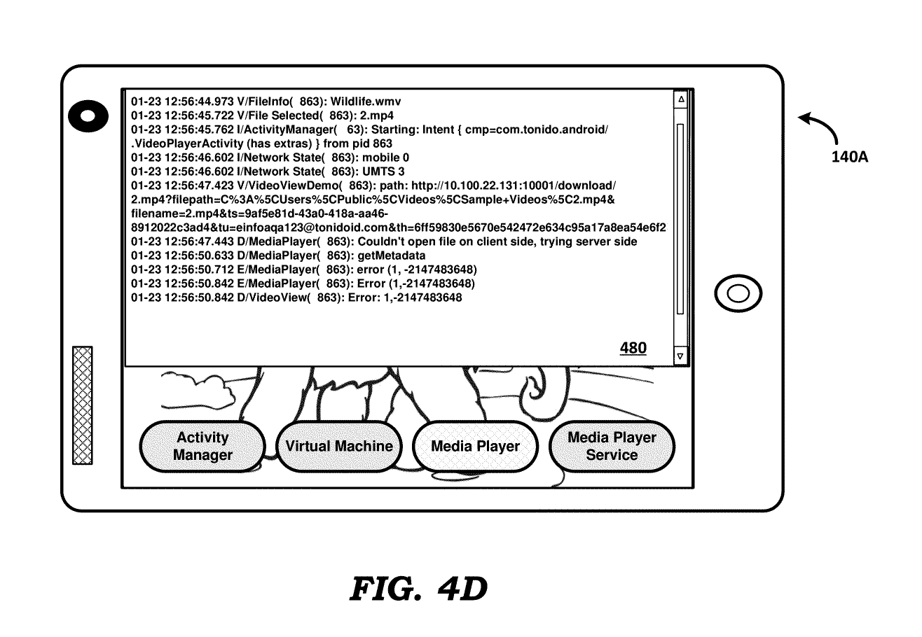

FIG. 3B depicts the manner in which a system error/error condition is identified (in a first phase) in one embodiment. Each of FIGS. 3B and 4A-4C depicts respective user interfaces displayed on a display unit associated with a mobile device (DUT 140A) in response to a user performing the test case of viewing a video file using awesome player 360. As noted above, awesome player 360 is executing on framework 300 provided on the mobile device.

Display area 380 depicts a portion of a user interface displayed on DUT 140A. Display area 370 indicates that the name of the software/user application being executed is “Awesome Player”, while display area 375 indicates that the name of the video file sought to be viewed is “2.mp4”.

Display area 390 depicts a pop-up that indicates to the user that a system error has occurred during the playing of the video file (“2.mp4”). The system error indicates that the software program was unable to perform the task request (i.e., to play the video file) as a part of the test case. It should be appreciated that the error conditions of interest may or may not coincide with the system errors, though the Example of FIGS. 3B and 4A-4C is described as having such coincidence, indicating the possibility that the error condition caused the system error.

Upon viewing such a system error (390), the user may send to testing tool 150, a further/second request to perform the tasks of the (same) test case again in a debug mode during a second phase. Testing tool 150 may accordingly perform the various tasks of the same test case while providing various features of the present disclosure as described below with examples.

### 5. Displaying and Highlighting Icons

In response to receiving a request to perform a test case in a debug mode/second phase, testing tool 150 identifies (for example, by examining a configuration data as described in detail below) the modules of interest in modular framework 300. Testing tool 150 then displays icons representing the modules of interest during the performance of each task specified in the test case as described in detail below.

FIGS. 4A-4C together illustrates the manner in which icons representing modules of interest are displayed (and highlighted) during the performance of a test case (in a second phase) in one embodiment. Each of the Figures is described in detail below.

Referring to FIG. 4A, display area 400 depicts a portion of a user interface displayed on DUT 140A, in response to a user performing the test case of viewing a video file (named “2.mp4”) using awesome player 360 (as indicated by “Awesome Player”). In particular, display area 400 is shown displaying the output of the first task of loading the video file. In particular, a progress bar control (“Loading . . . ”) indicating the percentage of the video file that has been loaded (in memory) is shown in display area 400.

Each of icons 421-424 represents a corresponding module of interest (sought to be monitored) in the performance of the test case on awesome player 360. In particular, icons 421-424 indicate that the modules “Activity Manager” (in application framework 320), “Media Player” (in applications & widgets 310), “Media Player Service” (in libraries 330) and “Virtual Machine” (in framework runtime 340) are of interest to the user/tester performing the testing of the software program.

In one embodiment, the specific modules of interest that are being invoked by the software program during the performance of each task of the test case are indicated by showing the corresponding icons in a different visual manner. Thus, while the loading task of the test case is being performed, icons 421 and 422 are shown in a different visual manner (vertically hatched) to indicate that the corresponding modules “Activity Manager” and “Virtual Machine” are being invoked during the performance of the loading task of the test case.

It may be observed that the icons are shown as an overlay over the output of performance of the loading task. The overlay ensures that icons 421-424 and the output of the performance of the task (progress bar) share the same display area portion (400) in the corresponding display duration.

Referring to FIG. 4B, display area 450 (similar to display area 400) depicts a portion of a user interface displayed on DUT 140A. Display area 450 is shown displaying the output of the second task of playing the video file. In particular, the output of display area 450 corresponds to a time instance at which the loading of the video file is completed and the playing of the video file has just started. Accordingly, a first image/frame at the beginning of the video file is shown displayed in display area 450.

It may be observed that all of the icons 421-424 are shown vertically hatched, indicating that all the corresponding modules are being invoked during the performance of the second task of playing the video file. It may be appreciated that the software program may invoke the Media Player module, which in turn may invoke the Media Player Service module.

Thus, a user is facilitated to identify if any of the specific modules of interest in the modular framework are invoked during the performance of each task (of the test case). Upon occurrence of an error condition, testing tool 150 is enabled to diagnose the specific module of interesting that is causing the error condition, and then highlight the icon corresponding to the specific module. The description is continued assuming that an error condition occurred at the start of playing the video file (that is, the start of the second task), and that testing tool 150 diagnosed that the Media Player is the module of interest that caused the error condition to occur.

Referring to FIG. 4C, display area 460 (similar to display area 390) indicates the occurrence of a system error/error condition during the playing of the video file (“2.mp4”). It may be observed that icon 473 is shown highlighted in a different format (filled with white color with gray cross hatch) to indicate that the “Media Player” module is the source of the error condition (and possibly the system error shown in display area 460). It should be noted that icon 473 is displayed by testing tool 150, in contrast to the pop-up of display area 460 which is generated by the software application in response to the occurrence of the error condition. As noted above, during the highlighting, icon 473 operates as a widget that can be selected (e.g., by clicking on) by the user.

Referring to FIG. 4D, display area 480 is shown displaying a portion of a log data generated by the various modules of the modular framework during the performance of the second task. It may be observed that the log data generated by “Activity Manager” and “Media Player” are shown displayed in display area 480. Display area 480 is displayed in response to the user selecting icon/widget 473 in FIG. 4C. The portion of the log data displayed indicates that an error has occurred while performing the streaming of the video over the network, and accordingly the Media Player module has failed to show the video on the display unit. The user is accordingly facilitated to determine a cause of the error conditions, potentially correlated with system errors, based on the corresponding portion of the log data displayed in display area 480.

Thus, the icons representing the invoked modules are displayed (and highlighted) during the performance of respective tasks of a test case on a software application executing on a modular framework. The manner in which testing too 150 may be implemented to provide several features of the present disclosure is described below with examples.

### 6. Testing Tool

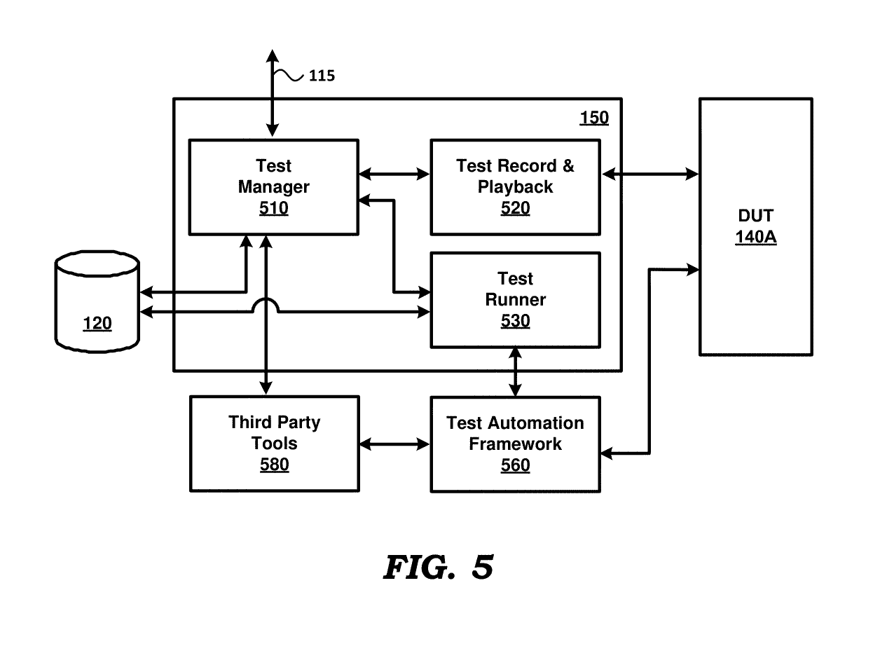

FIG. 5 is a block diagram of a testing tool (150) in one embodiment. The block diagram is shown containing test manager 510, test record & playback 520, test runner 530 (all shown within testing tool 150), test automation framework 560, and third party tools 580. Each of the blocks is described in detail below.

Test manager 510 receives requests (via path 115) for executing test cases on a software program from users using one of end user systems (160A-160C) and processes the received requests. Test manager 510 may first determine whether the requesting user has sufficient rights for accessing the test cases and/or the software program. Testing manger 510 may then execute the software program on the DUT (140A) by sending appropriate commands, retrieve the requested test case from data store 120, and then perform the tasks of the test case on the software program executing in DUT 140A.

In one embodiment, test manager 510 uses test automation framework 560 to perform the tasks specified by a test case. Test automation framework 560 represents a software application executing in server system 180 that facilitates the execution of a test case on a DUT (such as 140A). Test automation framework 560 is designed to operate specifically with the modular framework provided on the DUT, and accordingly simplifies the operation of executing each task in the test case and capturing the result of performance of the task in textual, image and/or movie formats. In alternative embodiments, test automation frame 560 can be executing on each of the DUTs sought to be tested.

Test runner 530 (provided within testing tool 150) acts as a bridge between test manager 510 and test automation framework 560. Test runner 530 receives a test case sought to be performed from test manager 510, and then forwards the received test case to test automation framework 560. The communication between test runner 530 and test automation framework 560 may be implemented using web services, with the data exchanged between the two blocks being in eXtensible Markup Language (XML) format. Test runner 530, also receives the result of running of the test case and stores the results in data store 120.

It may be noted that the results of testing are different from the logs captured by test record & playback 520, as described below. The results of testing indicate the success or failure of performance of the tasks of a test case, and are provided by test automation framework 560. In contrast, the captured logs are generated by modular framework 300 executing in DUT 140A.

Third party tool 580 represents various bug tracking, version control, and other proprietary software applications (assumed to be executing in server system 180) that may be used (instead of test runner 530) by test manager 510 to interface with test automation framework 560. In such an embodiment, test manager 510 may receive the result of performance of a test case from third party tools 580 and store the received results in data store 120.

Test record & playback (TRP) 520 records the logs generated by the software program and the various modules invoked in modular framework during the execution of the test case in DUT 140A. The capturing of the logs may be performed after connecting to DUT 140A. The connection may be established via USB, Wi-Fi or Ethernet (as noted above), with the data then exchanged using one or more of the protocols such as ssh, adb usb/adb wireless (used when DUT is providing an Android framework), serial connection, telnet, etc. The connection to a DUT may be disconnected after all the user requested test cases have been run on the DUT.

It may be appreciated that only a single DUT is shown in FIG. 5. However, in typical environments, testing tool 150 (in particular, test manager 510) may be required to interface with and execute test cases on multiple DUTs simultaneously. To handle such a scenario, test manager 510 is implemented using a multi-threaded architecture, wherein there is a dedicated thread created for each DUT. The dedicated thread is designed to establish the connection to the DUT, send the test case for performance on the DUT (using test automation framework 560), receive the result of performance of each task, and also to capture the log data generated during the performance of the test case (by TRP 520).

It may be appreciated that several features of the present disclosure may be provided by TRP 520 during the performance of the various tasks of a user request test case as described below with examples.

### 7. Running a Test Case

As noted above, testing tool 150 may run a test case in a first phase (non-debug mode), and then in a second phase (debug mode) only if an error condition (such as error shown in display area 390) occurs in the first phase. In one embodiment, TRP 520 records the log generated during the first/non-debug phase, and then parses the recorded log to determine the occurrence of error conditions (390) during the running of the test case in the first phase. In a scenario that an error condition is determined to have occurred during the first phase, TRP 520 runs the test case in second/debug phase. TRP 520 also facilitates the playback of the log in both the non-debug/debug phases. The term “playback” entails that when a log for a test case already exists, TRP 520 facilitates the same test case to be executed again in a debug/non-debug mode.

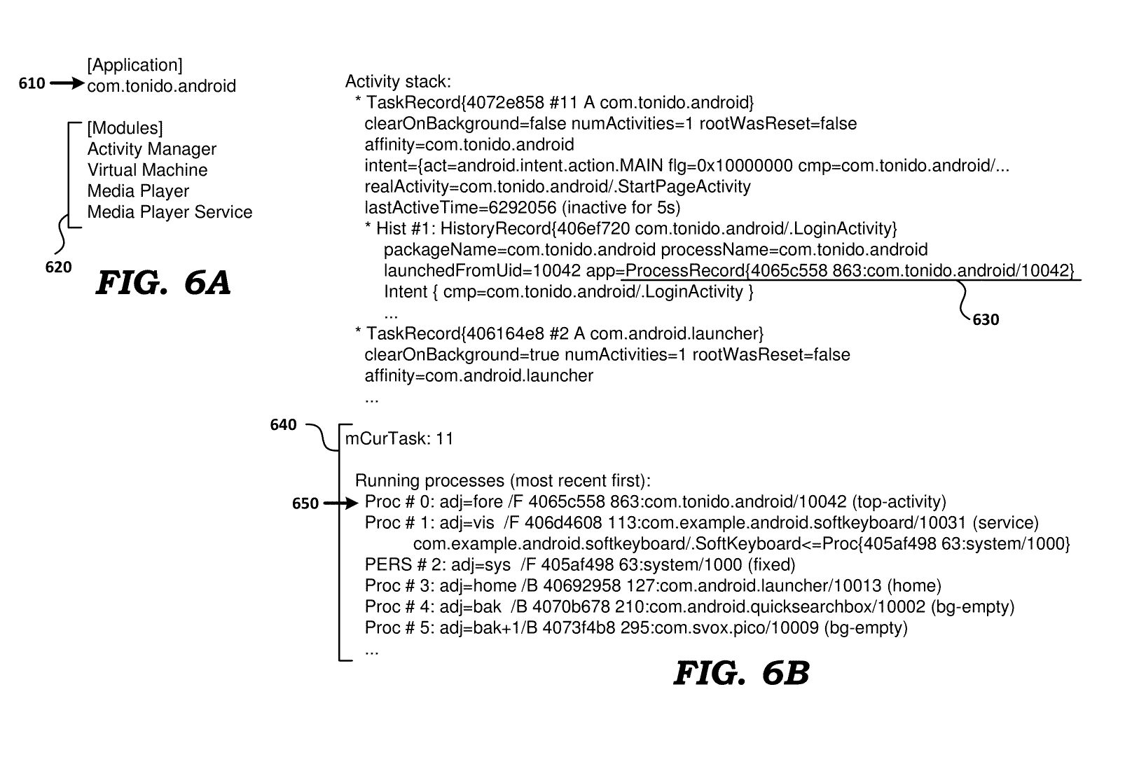

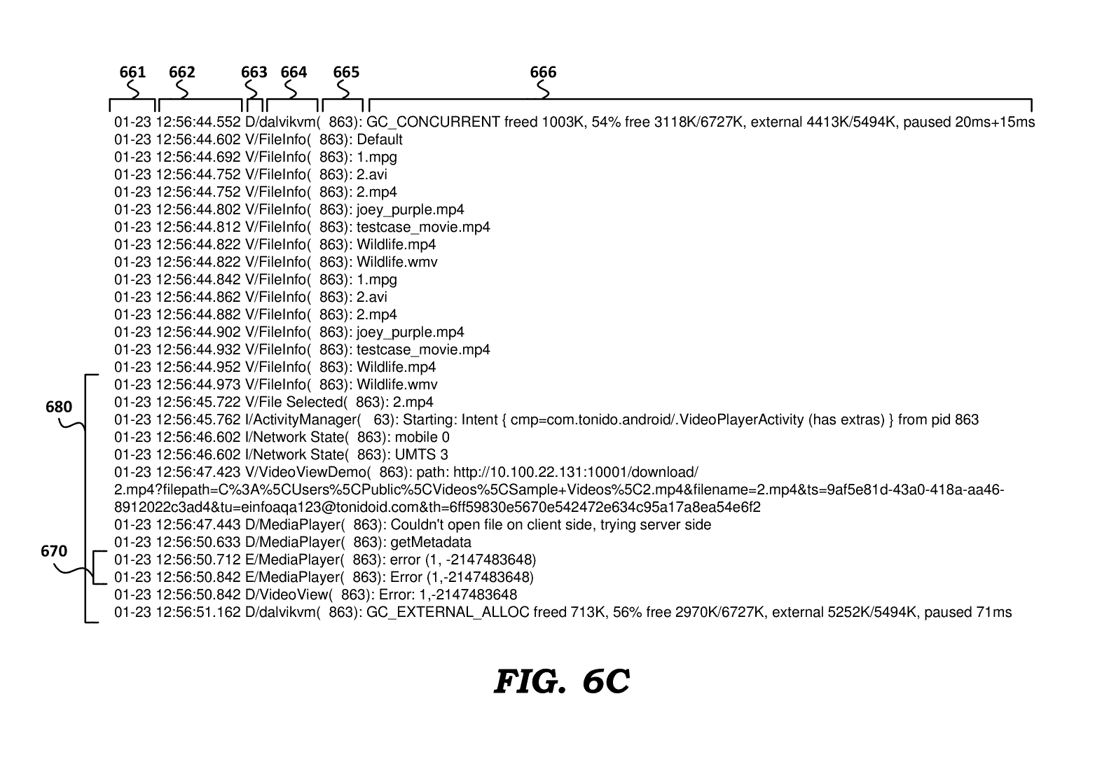

In response to running a test case in debug mode, TRP 520 first identifies a set of modules of interest by examining a configuration data provided by the user/tester. FIG. 6A depicts a portion of a configuration data in one embodiment. The data of FIGS. 6A-6C may be maintained in data store 120.

Data portion 610 indicates the deployment name of the software program as being “com.tonido.android” (corresponding to awesome player 360), while data portion 620 specifies a list of modules of interest (to the user/tester) in the running of the test case. In response to the configuration data of FIG. 6A, TRP 520 displays the various icons corresponding to the modules of interest as described above with respect to FIG. 4A (and also 4B).

During the performance of a task on DUT 140, such as the loading task noted above, TRP 520 captures the log data generated by the modular framework (and in particular, the modules of interest) by interfacing with DUT 140A. It may be appreciated that there may be multiple software programs executing concurrently (or at least being active concurrently in a memory) in DUT 140A, and it may accordingly be required to identify the specific log data generated only by the specific software program under testing (awesome player 360).

In one embodiment, TRP 520 first identifies at each time instance (or at pre-determined intervals), the currently active (referred to as “top activity”) software program in DUT 140A by examining an activity stack provided by the modular framework. FIG. 6B depicts a portion of an activity stack data provided by a module framework in one embodiment. Data portion 630 indicates that the software program having the deployment name “com.tonido.android” is associated with the unique process identifier 863. Data portion 640 indicates that there are currently 11 tasks that are active/in memory, while data portion 650 indicates the name/process identifier of the top activity. It may be observed that data portion 650 indicates that the software program awesome player 360 is the top activity in the stack.

It may be appreciated that the identification of the process identifier facilitates TRP 520 to filter (based on the process identifier) the log data generated by the different software programs currently executing in DUT 140A. Furthermore, in response to the identification of the software program as the top activity, TRP 520 is enabled to provide several features of the present invention such as showing the icons as an overlay, highlighting the icon corresponding to the module causing the error condition, show relevant portions of the log data when the highlighted icons is selected by a user, etc.

FIG. 6C depicts a portion of a log data generated by a modular framework in one embodiment. The log data is shown containing multiple lines/log outputs, each line/log output being generated at a corresponding date and time (fields 661 and 662 respectively) by a corresponding module such as “Media Player”, “ActivityManager”, etc. as indicated in field 664. Field 665 indicates that the log outputs have been generated in response to the modules being invoked by the process having process identifier 863, that is, awesome player 360. Thus, the log data of FIG. 6C represents the data after TRP 520 has performed the above noted filtering based on the process identifier (863).

Field 666 specifies the details of a message generated by the module as part of the log output. Field 663 (the character before the slash) indicates a log level corresponding to each log output. In particular, the character “D” in field 663 indicates a debug level output that is primarily used for debugging the software program, the character “I” indicates a info level output used for providing information to the user/tester and the character “E” indicates a error level output that specifies the occurrence of an error during execution.

Thus, TRP 520 captures and inspects (in particular field 663 of) the lines/log outputs generated by the various modules of the modular framework to determine the occurrence of an error condition. In response to field 663 of a log output having the character “E” (for example, as shown in data portion 670), TRP 520 determines that an error condition has occurred and accordingly diagnoses (by inspecting the value of field 664) the corresponding module causing the error condition.

Thus, for data portion 670, TRP 520 diagnoses that the module “MediaPlayer” is the source of the error condition. TRP 520 may accordingly highlight the corresponding icon (473) on the display unit, as described above with respect to FIG. 4C. In a scenario that TRP 520 diagnoses that the source of the error condition is a module not specified in the configuration data of FIG. 6A, none of the icons (421-424) on the display unit are highlighted to indicate that none of the modules of interest is the source of the error condition.

In response to a user selecting the highlighted icon 473 (which acts as a widget), TRP 520 then provides a corresponding portion of the log data of FIG. 6C on the display unit as described above with respect to FIG. 4D. It may be observed that the portion of log data shown in display area 480 of FIG. 4D corresponds to the log data shown in data portion 680 of FIG. 6C.

Thus, testing tool 150 (and in particular, TRP 520) facilitates a user to determine whether any of the modules of interest (data portion 620) in a modular framework (FIG. 3A) is the source of error conditions during execution of a software program (360). As such, the system testing of the software programs executing on a modular framework is simplified. Such simplification is particularly useful when the source code of the tested software program is unavailable.

It should be further appreciated that the features described above can be implemented in various embodiments as a desired combination of one or more of hardware, executable modules, and firmware. The description is continued with respect to an embodiment in which various features are operative when the software instructions described above are executed.

### 8. Digital Processing System

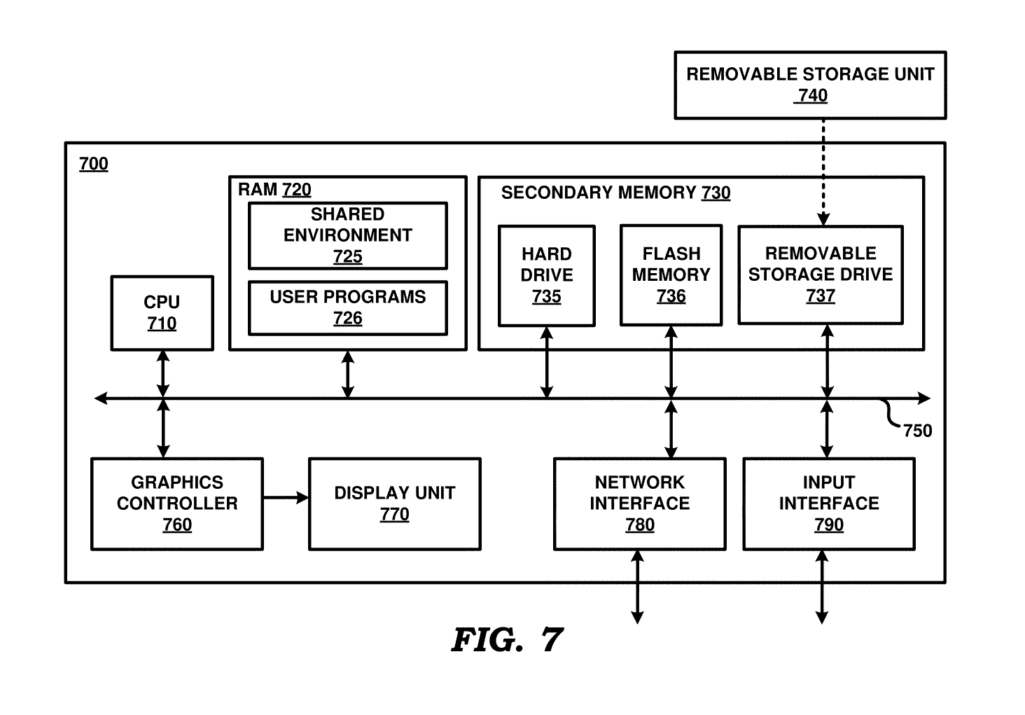

FIG. 7 is a block diagram illustrating the details of digital processing system 700 in which various aspects of the present disclosure are operative by execution of appropriate software instructions. Digital processing system 700 may correspond to any system (such as server system 180) executing testing tool 150 or one of DUT 140A-140D.

Digital processing system 700 may contain one or more processors (such as a central processing unit (CPU) 710), random access memory (RAM) 720, secondary memory 730, graphics controller 760, display unit 770, network interface 780, and input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present disclosure. CPU 710 may contain multiple processing units, with each processing unit potentially being designed for a specific task. Alternatively, CPU 710 may contain only a single general-purpose processing unit.

RAM 720 may receive instructions from secondary memory 730 using communication path 750. RAM 720 is shown currently containing software instructions constituting shared environment 725 and/or user programs 726 (such as networking applications, database applications, etc.). Shared environment 725 contains utilities shared by user programs, and such shared utilities include operating system, device drivers, virtual machines, flow engine, etc., which provide a (common) run time environment for execution of user programs/applications. It may be readily appreciated that shared environment 725 may be viewed as a modular framework executing user/software programs.

Graphics controller 760 generates display signals (e.g., in RGB format) to display unit 770 based on data/instructions received from CPU 710. Display unit 770 contains one or more display screens (providing a unified display interface) to display the images defined by the display signals (such as the portions of the user interfaces shown in FIGS. 3B and 4A-4D). Input interface 790 may correspond to a keyboard and a pointing device (e.g., touch-pad, mouse) and may be used to provide the user inputs (such as the inputs specified in the portions of the user interface shown in FIGS. 3B and 4A-4D) required for several aspects of the present disclosure. Network interface 780 provides connectivity to a network (e.g., using Internet Protocol), and may be used to communicate with other connected systems (such as client systems 110A-110Z, server systems 160A-160C, data store 180, etc.) of FIG. 1.

Secondary memory 730 may contain hard drive 735, flash memory 736, and removable storage drive 737. Secondary memory 730 may store the data (for example, portions of the data shown in FIGS. 6A-6C) and software instructions (for implementing the steps of FIG. 2), which enable digital processing system 700 to provide several features in accordance with the present disclosure. The code/instructions stored in secondary memory 730 may either be copied to RAM 720 prior to execution by CPU 710 for higher execution speeds, or may be directly executed by CPU 710.

Some or all of the data and instructions may be provided on removable storage unit 740, and the data and instructions may be read and provided by removable storage drive 737 to CPU 710. Removable storage unit 740 may be implemented using medium and storage format compatible with removable storage drive 737 such that removable storage drive 737 can read the data and instructions. Thus, removable storage unit 740 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 740 or hard disk installed in hard drive 735. These computer program products are means for providing software to digital processing system 700. CPU 710 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 730. Volatile media includes dynamic memory, such as RAM 720. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 750. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 9. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method of facilitating system testing of software programs, said method comprising:
executing a software program on a modular framework, said modular framework containing a plurality of modules;
running a test case on said software program during execution, said test case specifying a set of tasks, wherein said software program is designed to invoke modules of said plurality of modules in the performance of each of said set of tasks;
identifying a set of modules of said plurality of modules as being of interest in said running of said test case;
displaying icons representing said set of modules during the performance of said set of tasks;
upon determining an occurrence of an error condition in performance of a first task of said set of tasks:
diagnosing a first module of said set of modules as causing said error condition; and
highlighting the icon representing said first module to indicate to a user that said first module is the source of said error condition.

2. The method of claim 1, wherein source code for said software program is unavailable during performance of said test case,
wherein said software program is included in said plurality of modules.

3. The method of claim 2, further comprising displaying an output of performance of a respective task of said set of tasks,
wherein said icons representing said set of modules are displayed as an overlay over said output.

4. The method of claim 3, wherein said set of modules are specified as part of a configuration data,
wherein said identifying comprises examining said configuration data to determine that said set of modules are of interest in said running of said test case.

5. The method of claim 4, wherein said plurality of modules includes modules from one or more of an operating system, virtual machine, application framework and a device driver.

6. The method of claim 1, wherein the icon representing said first module operates as a widget in a duration when highlighted, said method further comprising:
capturing a log data generated during the performance of said test case; and
providing a corresponding portion of said log data generated by said set of modules in response to a user selecting said widget,
whereby said user is facilitated to determine a cause of said error condition based on said corresponding portion of said log data.

7. The method of claim 6, wherein said test case is first run in a first phase prior to said performance of said executing, said running, said identifying, said displaying, said determining, said diagnosing and said highlighting in a second phase,
wherein said first phase is a non-debug mode and said second phase is a debug mode which is performed only if said error condition occurs in said first phase.

8. A non-transitory machine readable medium storing one or more sequences of instructions for causing a system to facilitate system testing of software programs, wherein execution of said one of more sequences of instructions by one or more processors contained in said system causes said system to perform the actions of:
executing a software program on a modular framework, said modular framework containing a plurality of modules;
running a test case on said software program during execution, said test case specifying a set of tasks, wherein said software program is designed to invoke modules of said plurality of modules in the performance of each of said set of tasks;
identifying a set of modules of said plurality of modules as being of interest in said running of said test case;
displaying an output of performance of a respective task of said set of tasks; and
displaying as an overlay over said output, icons representing said set of modules during the performance of said set of tasks.

9. The machine readable medium of claim 8, further comprising one or more instructions for:
upon determining an occurrence of an error condition in performance of a first task of said set of tasks:
diagnosing a first module of said set of modules as causing said error condition; and
highlighting the icon representing said first module to indicate to a user that said first module is the source of said error condition.

10. The machine readable medium of claim 9, wherein said set of modules are specified as part of a configuration data,
wherein said identifying comprises one or more instructions for examining said configuration data to determine that said set of modules are of interest in said running of said test case.

11. The machine readable medium of claim 10, wherein said plurality of modules includes modules from one or more of an operating system, virtual machine, application framework and a device driver.

12. The machine readable medium of claim 9, wherein the icon representing said first module operates as a widget in a duration when highlighted, further comprising one or more instructions for:
capturing a log data generated during the performance of said test case; and
providing a corresponding portion of said log data generated by said set of modules in response to a user selecting said widget,
whereby said user is facilitated to determine a cause of said error condition based on said corresponding portion of said log data.

13. The machine readable medium of claim 12, wherein said test case is first run in a first phase prior to said performance of said running, said identifying, said displaying, said determining, said diagnosing and said highlighting in a second phase,
wherein said first phase is a non-debug mode and said second phase is a debug mode which is performed only if said error condition occurs in said first phase.

14. A computing system comprising:
a device under test (DUT) to execute a software program on a modular framework, said modular framework containing a plurality of modules; and
a testing tool operable to:
run in said DUT, a test case on said software program during execution, said test case specifying a set of tasks, wherein said software program is designed to invoke modules of said plurality of modules in the performance of each of said set of tasks;
identify a set of modules of said plurality of modules as being of interest in said running of said test case;
display, on a display unit associated with said DUT, icons representing said set of modules during the performance of said set of tasks,
wherein said testing tool displays said icons as an overlay over an output of performance of a respective task of said set of tasks displayed on said display unit.

15. The computing system of claim 14, wherein said testing tool is further operable to:
upon determining an occurrence of an error condition in performance of a first task of said set of tasks:
diagnose a first module of said set of modules as causing said error condition; and
highlight, on said display unit, the icon representing said first module to indicate to a user that said first module is the source of said error condition.

16. The computing system of claim 15, wherein said set of modules are specified as part of a configuration data,
wherein for said identifying, said testing tool is operable to examine said configuration data to determine that said set of modules are of interest in said running of said test case.

17. The computing system of claim 16, wherein said plurality of modules includes modules from one or more of an operating system, virtual machine, application framework and a device driver.

18. The computing system of claim 15, wherein the icon representing said first module operates as a widget in a duration when highlighted, said testing tool further operable to:
capture a log data generated during the performance of said test case; and
provide a corresponding portion of said log data generated by said set of modules in response to a user selecting said widget,
whereby said user is facilitated to determine a cause of said error condition based on said corresponding portion of said log data.

19. The computing system of claim 18, wherein said testing tool first runs said test case in a first phase prior to the performance of said running, said identifying, said displaying, said determining, said diagnosing and said highlighting in a second phase,
wherein said first phase is a non-debug mode and said second phase is a debug mode which is performed only if said error condition occurs in said first phase.
